(19) United States
(12) Patent Application Publication
(10) Pub. No.: US 2024/0357309 A1
(43) Pub. Date: Oct. 24, 2024

(54) DIRECTIONAL AUDIO SOURCE SEPARATION USING HYBRID NEURAL NETWORK

(71) Applicant: University of Washington, Seattle, WA (US)

(72) Inventors: Shyamnath Gollakota, Seattle, WA (US); Anran Wang, Seattle, WA (US)

(73) Assignee: University of Washington, Seattle, WA (US)

(21) Appl. No.: 18/688,317

(22) PCT Filed: Oct. 20, 2022
(86) PCT No.: PCT/US2022/078472

§ 371 Date: Feb. 29, 2024

Related U.S. Application Data
(60) Provisional application No. 63/270,315, filed on Oct. 21, 2021.

(51) Int. Cl. H04S 7/00; G10L 25/30; H04R 3/00; H04R 5/027

(52) U.S. Cl. CPC H04S 7/304; G10L 25/30; H04R 3/005; H04R 5/027; H04S 2400/11; H04S 2400/15

(57) ABSTRACT

Embodiments of the present disclosure provide systems and methods directed to directional audio source separation. An example method comprising: receiving a plurality of input signals by a plurality of microphones: generating a plurality of beamformed signals based on the plurality of input signals: providing the plurality of beamformed signals and the plurality of input signals to a neural network, wherein the neural network is trained to generate directional signals based on sample beamformed signals and sample input signals: generating an output directional signal using the neural network based on the plurality of input signals and the plurality of beamformed signals: and providing the directional signal to a speaker.

### RELATED APPLICATIONS

This application claims priority to U.S. Provisional Application No. 63/270,315 filed Oct. 21, 2021, which is incorporated herein by reference, in its entirety, for any purpose.

### STATEMENT REGARDING RESEARCH & DEVELOPMENT

This invention was made with government support under Grant No. 1812559, awarded by the National Science Foundation (NSF). The government has certain rights in the invention.

### TECHNICAL FIELD

Examples described herein generally relate to directional audio separation. Examples of directional audio separation using neural networks and in some cases using prebeamforming techniques are described.

### BACKGROUND

Directional hearing generally refers to a technique to amplify speech from a specific direction while reducing sounds from other directions. Directional hearing can be applied to various technologies from medical devices to augmented reality and wearable computing. For example, hearing aids with the directional hearing technique can help individuals with hearing impairments who have increased difficulty hearing in the presence of noise and interfering sounds. Hearing aids combined with augmented reality headsets to customize the sounds and noises from different directions, such as sensors like gaze trackers, may enable a wearer to be in a noisy room and amplify speech from a specific direction, simply by looking toward the specific direction. For decades, the predominant approach to achieving this goal was to perform beamforming. While these signal processing techniques can be computationally light-weight, they have limited performance metrics. Neural networks may achieve exceptional source separation in comparison but are computationally expensive and to date cannot run on-device on wearable computing platforms.

Directional hearing applications impose stringent computational, real-time and low-latency requirements that are not met by any existing source separation networks. Specifically, compared to other audio applications like teleconferencing where latencies on the order of 100 ms are adequate, directional hearing would advantageously utilize real-time audio processing with much more stringent latency requirements. While powerful graphics processing units (GPUs) and specialized inference accelerators (e.g., TPU) can speed up the network run-time, they are usually not available on a wearable device given their power, size and weight requirements. In fact, even the central processing unit (CPU) capabilities and memory bandwidth available on wearables can be significantly constrained even compared to smartphones. For example, processors used in wearable devices, such as Google glasses and Apple watch, are significantly slower than the processors in smartphones, such as iPhone 12. Offloading computation to other devices (e.g., smartphones) from the wearable devices may cause latency that is unacceptable for wearable devices and medical devices.

### SUMMARY

Embodiments described herein are directed towards systems and methods for directional audio separation. In operation, a plurality of input signals are received by a plurality of microphones. In some embodiments, the plurality of microphones are positioned on an augmented or virtual reality headset, and wherein the speaker is positioned in the augmented or virtual reality headset.

In operation, prebeamforming may be performed based on the plurality of input signals and provide beamformed signals. In some embodiments, the plurality of beamformed signals may include spatial information. In some embodiments, first circuitry may beamform input signals received at the plurality of microphones to provide first intermediate signals, and second circuitry may beamform the input signals to provide second intermediate signals. In some embodiments, the first circuitry and the second circuitry may utilize direction information. In some embodiments, the first circuitry may perform one of superdirective beamforming, online MVDR beamforming or WebRTC non-linear beamforming, and the second circuitry may perform one of superdirective beamforming, online MVDR beamforming or WebRTC non-linear beamforming that is different from the first circuitry.

In operation, the plurality of beamformed signals and the plurality of input signals to a neural network that is trained to generate a directional signal based on sample input beamformed signals. In some embodiments, the neural network may be coupled to the first circuitry and the second circuitry, and the neural network may generate an output directional signal based on the first intermediate signals, the second intermediate signals, and at least a portion of the input signals. In some embodiments, the neural network may include an encoder, a separator, and a decoder. In some embodiments, the neural network may utilize complex tensors. In some embodiments, the neural network may perform a component-wise operation and a rectifier activation function. In some embodiments, the neural network may include a plurality of temporal convolutional networks (TCNs) including a first TCN and a second TCN, and the neural network may downsample a first TCN signal from the first TCN, and provide a second TCN signal that is the downsampled first TCN signal to the second TCN. In some embodiments, the first TCN may include a plurality of convolution layer, and a last convolution layer of the plurality of convolution layers may provide the first TCN signal. In some embodiments, the last convolution layer may further provide the first TCN signal to a later layer that is not adjacent to the last convolution layer.

In operation, a speaker coupled to the neural network may play the output directional signal. In some embodiments, the speaker may be positioned in the headphone.

### BRIEF DESCRIPTION OF THE DRAWINGS

FIG. 1 is a schematic illustration of a system for directional audio source separation in accordance with examples described herein.

FIG. 2 shows a formula representing a signal received by one of microphones in accordance with examples described herein.

FIG. 3 shows a formula representing a signal received by one of microphones that is shifted in a direction in accordance with examples described herein.

FIG. 4 is a schematic illustration of a network including strided and dilated convolution in accordance with examples described herein.

FIG. 5 is a schematic illustration of an example of a temporal convolution network (TCN) arranged in accordance with examples described herein.

FIG. 6 shows an activation function used in a convolutional sequence in accordance with examples described herein.

FIG. 7 shows a hyperbolic tangent function used after the convolutional sequence 502 in accordance with examples described herein.

FIG. 8 is a schematic illustration of a system using directional audio source separation in accordance with examples described herein.

FIG. 9A is a schematic illustration of a microphone array arrangement on a headphone in accordance with examples described herein.

FIG. 9B is a schematic illustration of a microphone array arrangement on an augmented reality device in accordance with examples described herein.

FIG. 9C is a schematic illustration of a microphone array arrangement on a pair of smart glasses in accordance with examples described herein.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific to embodiments in which the described systems and methods may be practiced. It is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense for the appended claims.

Various embodiments described herein are directed to systems and methods for improved real-time directional hearing using a system for directional audio source separation. A system for directional audio source separation may include, but is not limited to, a plurality of beamformers and a neural network.

In some embodiments, examples of a plurality of beamformers may receive a plurality of input signals from microphones and a direction information from a direction sensor. In some examples, the microphones and the direction sensor may be located on a wearable device, such as a headphone, a watch, an AR device or headset, or a pair of smart glasses. In some examples, the direction sensor may be a gaze sensor of the wearable device.

In some examples, the plurality of beamformers may be implemented to provide spatial information as a plurality of beamformed signals to the neural network. The plurality of beamformers may use different beamforming techniques from one another, from different classes of beamforming techniques from non-adaptive, adaptive and non-linear approaches. For example, the plurality of beamformers may include at least one of a superdirective beamformer, an online minimum-variant distortionless-response (MVDR) beamformer, a Web Real-Time Communication (RTC) non-linear beamformer, or a binaural beamformer. The plurality of beamformers may reduce complexity of the neural network and its computational cost while providing spatial information to the neural network.

In some embodiments, a neural network may receive the plurality of beamformed signals and the plurality of input signals. The neural network may be trained to generate directional signals based on sample beamformed signals and sample input signals. The neural network may use direction information in the plurality of beamformed signals. The output directional signal includes an acoustic signal in the input signals projected from a direction based on the direction information. The acoustic signal may be provided to a speaker for reproduction. In this manner, a speaker may output sound that is preferentially received from a particular direction.

Examples of a neural network described herein may utilize a complex tensor. Parameters used in the neural network may be represented in the complex tensor to reduce a model size of the neural network.

In some examples, a neural network may perform a component-wise operation and a rectifier activation function. In some embodiments, the component-wise operation and the rectifier activation function may be performed as one activation function. The activation function operation linearly transforms two-dimensional complex space that may simulate both conjugate and phase scaling, and then a rectifier function may be performed on real and imaginary parts independently. In some examples, a neural network may apply a hyperbolic tangent function to an amplitude of the complex tensor.

Examples of a neural network may include a separator including dilated and strided complex convolution stacks. For example, the dilated and strided complex convolution stacks may include a plurality of temporal convolutional networks (TCNs) including adjacent TCNs, such as a first TCN and a second TCN. The first TCN provide a first TCN signal for downsampling, and a second TCN signal that is the downsampled first TCN signal may be provided to the second TCN. Each TCN includes a plurality of convolution layers, such as causals that are convolutional filters. The first TCN includes a plurality of convolution layers, including a last convolution layer that provides the first TCN signal. The last convolution layer may further provide the first TCN signal to a later layer that is not adjacent to the last convolution layer (e.g., a skip-connection).

Advantageously, systems and methods described herein may utilize directional audio source separation performed using pre-beamforming and a neural network. Examples of such directional audio source separation systems and methods not only facilitate fast computation by using pre-beamforming that is suitable for performance on wearable and/or medical devices. In addition to offering fast computation, examples of systems and methods described herein may also provide comparable accuracy to more complex systems using neural networks described herein for processing multi-channel audio input signals. While various advantages of example systems and methods have been described, it is to be understood that not all examples of the described technology may have all, or even any, of the described advantages.

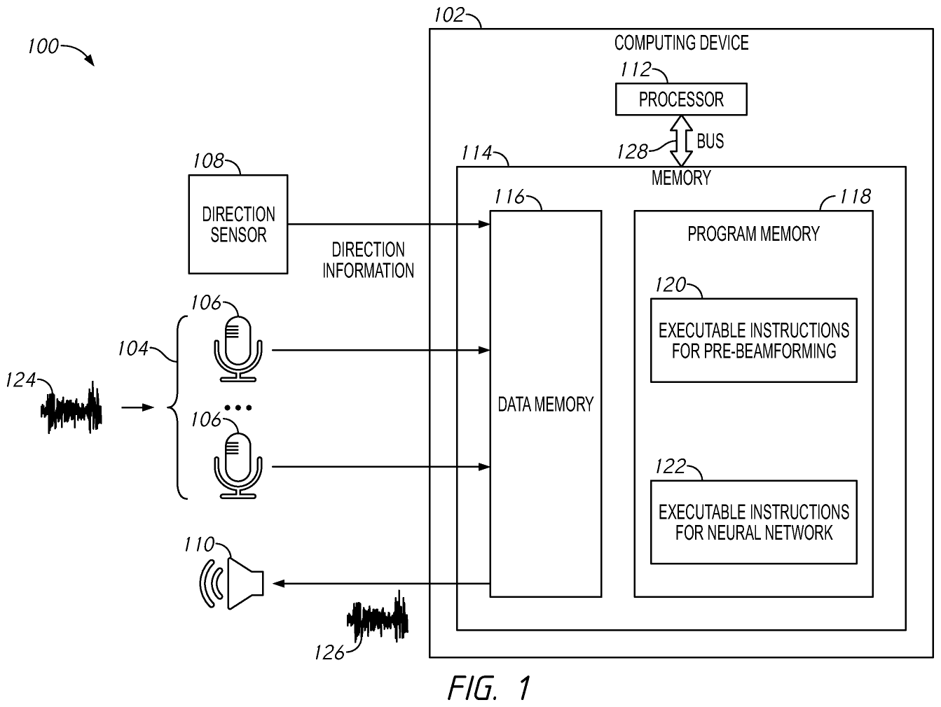

FIG. 1 is a schematic illustration of a system 100 for directional audio source separation arranged in accordance with examples described herein. It should be understood that this and other arrangements and elements (e.g., machines, interfaces, function, orders, and groupings of functions, etc.) can be used in addition to or instead of those shown, and some elements may be omitted altogether. Various functions described herein as being performed by one or more components may be carried out by firmware, hardware, and/or software. For instance, and as described herein, various functions may be carried out by a processor executing instructions stored in one or more memory devices.

System 100 of FIG. 1 includes a computing device 102, a microphone array 104, a direction sensor 108 and a speaker 110. The computing device 102 includes processor 112 and memory 114. The memory 114 may include data memory 116 and program memory 118. The program memory 118 may include executable instructions for pre-beamforming 120 and executable instructions for neural network 122. The microphone array 104 includes microphones 106. It should be understood that the system 100 shown in FIG. 1 is an example of one suitable architecture for implementing certain aspects of the present disclosure. Additional, fewer, and/or different components may be used in other examples.

In some examples, the system 100 may be implemented as a wearable device. A wearable device generally refers to a computing device which may be worn by a user (e.g., on a head, arm, finger, leg, foot, wrist, ear). However, it should be noted that the system 100 may be implemented using other types of devices such as mobile computing devices (e.g., those carried or transported by a user, such as mobile phones, tablets, or laptops) and static computing devices (e.g., those which generally remain in one place such as one or more desktop computers, smart speakers) that accept sound input and directional information and provide sound output. In some examples, the system 100 may be implemented using one or more medical devices, such as a hearing aid. Any and all such variations, and any combination thereof, are contemplated to be within the scope of implementations of the present disclosure.

Further, although the processor 112 and the memory 114 are illustrated as separate components of the computing device 102, and a single memory 114 is depicted as storing a variety of different information, any number of components can be used to perform the functionality described herein. Although illustrated as being a part of the computing device 102, the components can be distributed via any number of devices. For example, the processor 112 can be provided via one device, or multiple devices of a single or multiple kinds, while the memory 114 may be provided as one or more memory devices of a single or multiple kinds. Further, although the direction sensor 108, the microphone array 104, the computer computing device 102 and the speaker 110 are illustrated as being a part of the system 100, such as a wearable device, any of these devices can be separate devices in communication with one another or integrated into one or more devices. For example, input/output devices, such as the direction sensor 108, the microphone array 104, the speaker 110, and the data memory 116 can be provided via one wearable device, while the processor 112 and the program memory 118 may be provided via another device or server if communications between the wearable device and the other device or server are acceptable for the wearable device, or negligible compared to pre-beamforming and neural network processing.

Examples of the microphone array 104 described herein may generally receive input acoustic signals 124 of FIG. 1. The microphone array 104 may include the microphones 106. While two or more microphones 106 are shown in FIG. 1, generally any number of microphones may be included in a microphone array described herein. Moreover, the microphones 106 may be arranged in an array or in a dispersed manner, such as at vertices of a polygon, etc. In some examples, the microphones 106 may be positioned on top of a headband of a headphone, and the speaker 110 may be positioned in the headphone. In some examples, the microphones 106 may be positioned on an augmented or virtual reality headset, and the speaker 110 may be positioned in the augmented or virtual reality headset. However, other arrangements of microphones and/or speakers may be used in other examples.

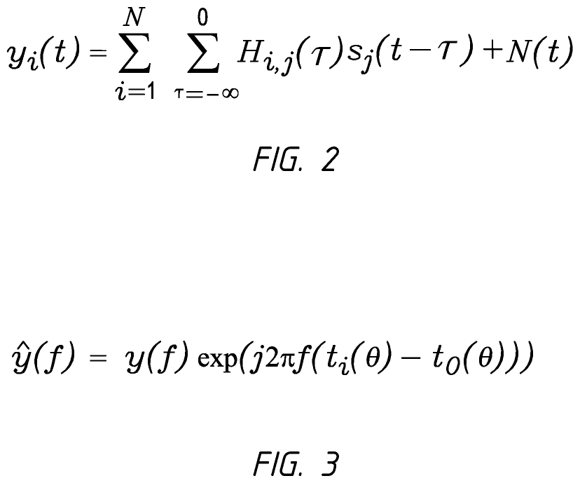

The microphones 106 may receive input acoustic signals 124 from a plurality of sound sources (e.g., N sound sources s_{1 . . . N}) emitted from a plurality of angles (e.g., angles θ_{1 . . . N}), including a target acoustic signal from a target direction (e.g., a direction with a target angle). The acoustic signal received by the ith microphone ith may be represented as yᵢ(t) in a formula of FIG. 2. In the formula, N(t) is random noise and H_{i,j} is an impulse response associated with sound source j, and microphone i that captures multi-path and reverberations. At a given time t and a known θₖ, the system 100 may provide the directional acoustic signal 126 estimated as sₖ(t), emitted from the direction θₖ, given y(t−W) . . . . y(t+L), where W is the reception field, and L is a small lookahead.

Examples of a direction sensor 108 described herein may generally obtain a target direction and provide direction information indicative of the target direction (e.g., a direction with a target angle). In some examples, the direction sensor 108 may be a gaze tracker of the system 100, such as an augmented reality (AR) device, mounted on a head. The direction sensor 108 may obtain a target direction (e.g., a direction with a target angle) by combining angle information using sets of video information of an eye on the head and an outer world with regards to the system 100. In some examples, the video information may be collected at least 30 Hz or higher to accurately estimate the target direction. The microphone array 104 and the direction sensor 108 may be communicatively coupled to a computing device, such as the computing device 102, that is capable of directional audio source separation in accordance with examples described herein.

Examples described herein may include computing devices, such as the computing device 102 of FIG. 1. The computing device 102 may in some examples be integrated with one or more microphone array(s), such as the microphone array 104, the direction sensor 108, and/or the speaker 110 described herein. In some examples, the computing device 102 may be implemented using one or more computers in wearable devices or medical devices, smart phones, smart devices, or tablets. The computing device 102 may facilitate directional audio source separation, and in some examples, facilitate a neural network and multiple beamformers. As described herein, the computing device 102 includes the processor 112 and memory 114.

In some embodiments, the computing device 102 may be physically and/or communicatively coupled to the microphone array 104, the direction sensor 108 and/or the speaker 110. In other embodiments, the computing device 102 may not be physically coupled to the microphone array 104, the direction sensor 108 and/or the speaker 110. The computer device 102 may be communicatively coupled with the microphone array 104, the direction sensor 108 and/or the speaker 110.

Computing devices, such as the computing device 102 described herein, may include one or more processors, such as the processor 112. Any kind and/or number of processor may be present, including one or more central processing units (CPUs), graphics processing units (GPUs), other computer processors, mobile processors, digital signal processors (DSPs), microprocessors, computer chips, and/or processing units configured to execute machine-language instructions and process data, such as executable instructions for pre-beamforming 120 and/or executable instructions for neural network 122. In some examples, the executable instructions for pre-beamforming 120 may include a plurality of sets of executable instructions for separate beamforming techniques. In some embodiments, the plurality of sets of executable instructions for separate beamforming techniques may be executed by a plurality of sets of corresponding circuitry, such as a corresponding plurality of DSPs.

Computing devices, such as the computing device 102, described herein may further include memory 114. The memory 114 may be any type or kind of memory (e.g., read only memory (ROM), random access memory (RAM), solid state drive (SSD), and secure digital card (SD card)). While a single box is depicted as the memory 114, the memory 114 may include any number of memory devices. The memory 114 may be in communication with (e.g., electrically connected to) the processor 112.

The memory 114 includes data memory 116 and program memory 118. The memory 114 may be communicatively coupled to the processor by a bus 128. The microphone array 104, the speaker 110, and the processor 112 may have access to at least one data store or repository, such as the data memory 116, which may store data related to generating, providing, and/or receiving acoustic signals and/or directional signals, various data used in beamforming techniques and/or neural network techniques described herein. Information stored in the data memory 116 may be accessible to multiple components of the system 100 in some examples. The content and volume of such information are not intended to limit the scope of aspects of the present technology in any way. Further, the data memory 116 may be a single, independent component (as shown) or a plurality of storage devices, portions of which may reside in association with the computing device 102, microphone array 104, direction sensor 108, speaker 110, another external computing device (not shown), and/or any combination thereof. The data memory 116 may be configured as a memory buffer that may receive and store acoustic signals from the microphone array 104 and/or one or more directional signals from the direction sensor 108. The data memory 116 may include a plurality of unrelated data repositories or sources within the scope of embodiments of the present technology. In some examples, the data memory 116 may be local to the computing device 102. The data memory 116 may be updated at any time, including an increase and/or decrease in the amount and/or types of data related to generating, providing, and/or receiving acoustic signals and/or directional signals, various data used in beamforming techniques described herein, and various data used in neural network techniques described herein.

The program memory 118 may store executable instructions for execution by the processor 112, such as the executable instructions for pre-beamforming 120 and executable instructions for neural network 122. The processor 112 is communicatively coupled to the data memory 116 that may receive signals from the microphone array 104 and the direction sensor 108. The processor 112, executing the executable instructions for pre-beamforming 120 and/or the executable instructions for neural network 122, may generate the directional acoustic signal 126. The directional acoustic signal 126 may be an acoustic signal in the input acoustic signals 124 which is from a particular direction and/or weighted to more predominantly feature the input from the particular direction.

Various techniques are described herein to perform directional audio source separation, based on the input acoustic signals 124 and the direction information. As one example technique, to extract directional acoustic signal 126, the processor 112 of the computing device 102, executing the executable instructions for pre-beamforming 120, may perform a plurality of beamforming processes in parallel as pre-beamforming, based on the input acoustic signals 124 collected by the microphone 106 of the microphone array 104 and the direction information from the direction sensor 108. For example, the input acoustic signals 124 and the direction information may be provided for superdirective beamforming. Superdirective beamforming may extract an acoustic signal of a sound under diffused noise. The input acoustic signals 124 and the direction information may be provided for online adaptive MVDR beamforming. Online adaptive MVDR beamforming may extract the spatial information from the past to suppress noise and interference. The input acoustic signals 124 and the direction information may be provided for WebRTC non-linear beamforming. The WebRTC non-linear beamforming may enhance a simple delay-and-sum beamforming by suppressing time-frequency components that are more likely noise or interference. These three statistical beamforming processes may provide different classes of beamforming techniques from non-adaptive, adaptive and non-linear approaches. These three statistical beamforming processes are merely examples; any combination of beamforming processes may be included to perform different classes of beamforming techniques. As a result, a plurality of beamforming processes generate a plurality of beamformed signals that may provide a diversity of spatial information. The pre-beamforming may be computationally efficient and may take shorter processing time and less processing power of the processor 112 than performing similar functionalities using neural network techniques. For example, the pre-beamforming may be performed by one or more digital signal processors (DSPs), which may be more efficient than utilizing a CPU and/or GPU in some examples. In some examples, circuitry, such as one or more field programmable gate arrays (FPGAs) and/or application specific integrated circuitry (ASICs) may be used to implement the pre-beamforming.

Generally, beamforming, including pre-beamforming, refers to the process of weighting and/or combining signals received at multiple positions to generate an output signal. The output signal may be said to be beamformed.

During the pre-beamforming, in some examples, input channels for the microphones 106 may be shifted to aim at an input direction, and each microphone 106 samples an input acoustic signal through each direct path simultaneously, and the signal \hat{ }y(f) based on the shifted channel based on the input channels y(f) may be computed as an equation in FIG. 3. In the equation, tᵢ(θ) is the time-of-arrival from direction θ on mic i. The signals on shifted channels along with the beamformed signals may be provided to a neural network implemented by the executable instructions for neural network 122.

One advantage of beamforming using neural networks may be improved sound separation performance than that by using traditional beamforming techniques. To extract the directional acoustic signal 126, the processor 112 of the computing device 102, executing the executable instructions for neural network 122, may perform separation of the directional acoustic signal 126 based on the input acoustic signals 124 collected by the microphones 106 and the plurality of beamformed signals that resulted from pre-beamforming, and may provide the directional acoustic signal 126 to the speaker 110. The speaker 110 may reproduce extracted sound from the target direction based on the directional acoustic signal 126. For example, the speaker 110 may be in an augmented reality (AR) or virtual reality (VR) headset, and the speaker 110 may preferentially reproduce the sound that originates from a gaze direction of a wearer of the headset. In another example, the speaker may be in a hearing aid that produces sound with a directional preference based on a gaze, a head direction, or other direction of a user based on a configuration.

In some examples, the executable instructions for neural network 122 may include instructions to implement a neural network, including a complex encoder, a separator and a complex decoder with one dimensional convolutional layers. In some cases the neural network is implemented as mobile deep neural network (DNN) engines, or any other type of neural network, or combination thereof. The executable instructions for neural network 122 may employ complex tensors in representing parameters in the instructions to reduce a model size of the neural network. For example, each parameter can be represented as [R, −I; I, R], instead of full 2×2 matrices while maintaining a comparable accuracy. Furthermore, the complex tensors may restrict a degree of freedom of the parameters by enforcing correlation between the real and imaginary parts of the parameters, which enhances generalization capacity. The complex tensors may provide signal phase manipulation that enables encoding spatial information.

Accordingly, examples of systems described herein may provide a set of beamformed signals which have been generated using one or more beamforming techniques. These beamformed signals may be generated, for example, using one or more DSPs or other specialized circuitry in some examples. The beamformed signals may be input to a neural network that has been trained to generate a directional output signal based on the beamformed signals. In this manner, the neural network needs not be as complex or computationally intensive as a neural network which received less processed input signals (e.g., input signals directly from the microphones). Rather, the neural network utilizes beamformed signals which themselves may be beamformed based on a direction of interest (e.g., a gaze direction).

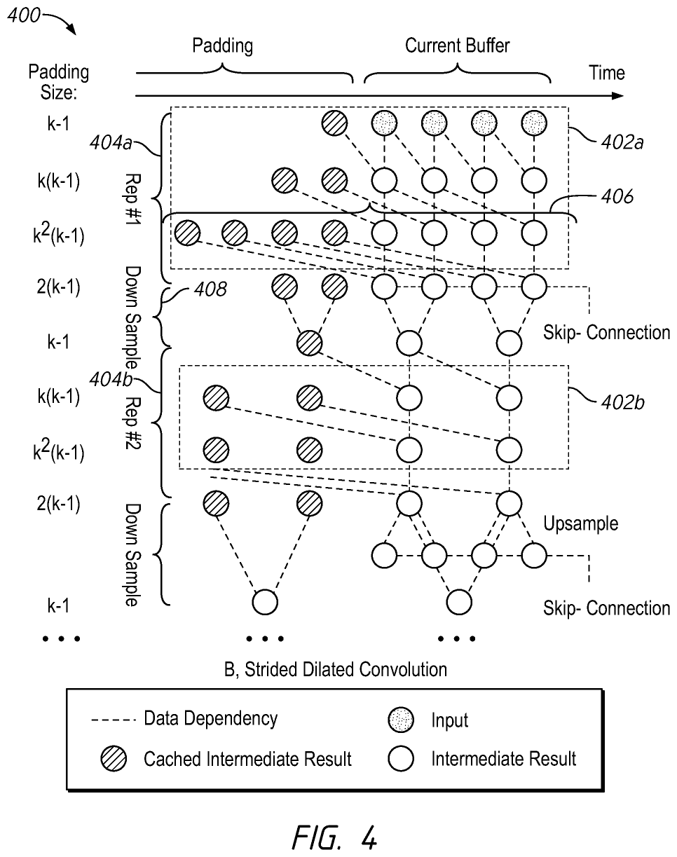

The executable instructions for neural network 122 to implement the separator may include instructions to implement dilated and strided complex convolution stacks. FIG. 4 is a schematic illustration of a network 400 including strided and dilated convolution in accordance with examples described herein. As shown in FIG. 4, the network 400 includes a stack of TCNs. A TCN 402a may include a plurality of dilated convolution layers 404a, and a TCN 402b may include a plurality of dilated convolution layers 404b. Between the TCN 402a and the TCN 402b, a 2×1 convolution layer 408 with stride being two has been included. Each convolution layer of the convolution layers 404a other than a last convolution layer 406 may provide output signals to each later adjacent layer. The last convolution layer 406 of the plurality of dilated convolution layers 404a of the TCN 402a may provide one or more signals to the 2×1 convolution layer 408. The 2×1 convolution layer 408 may downsample the one or more signals from the TCN 402a, and provide a signal that is a downsampled signal from the TCN 402a to the TCN 402b. The signal provided to the later layer may be upsampled using the nearest neighborhood method accordingly to an original sampling rate before summing up. Thus, a combination of strided and dilated convolution stacks may reduce a memory copy overhead caused by copying data from input padding to a current buffer and shifting the input padding for a new buffer. The dilated and strided complex convolution stacks may reduce memory footprint and memory copy per time step while keeping a large receptive field. The last convolution layer 406 of the plurality of dilated convolution layers 404a of the TCN 402a may also provide the one or more signals to a later layer that is not adjacent to the last convolution layer 406 (skip-connection). By reducing the skip-connections limiting to the last convolution layer 406, computations may be reduced.

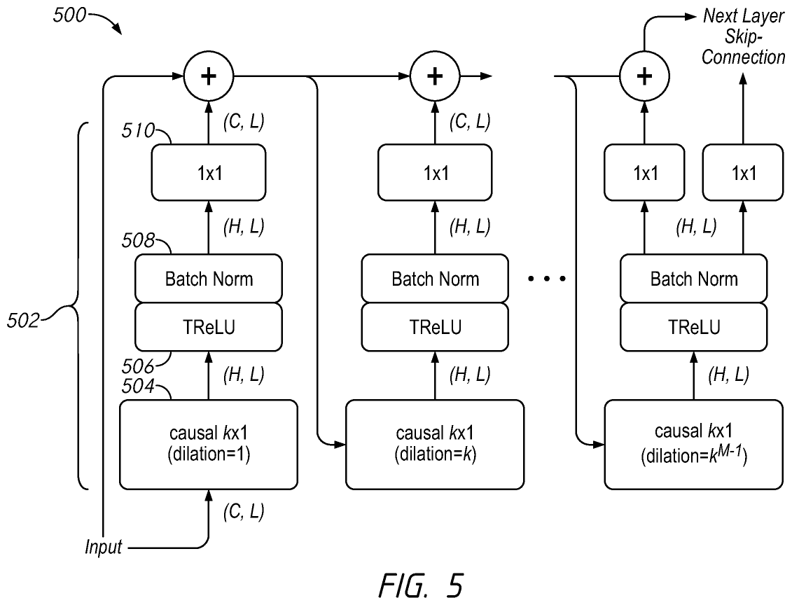

FIG. 5 is a schematic illustration of an example of a TCN 500 arranged in accordance with examples described herein. The executable instructions for neural network 122 to implement the separator may include instructions to implement the TCN 500. The TCN 500 may include a plurality of convolutional sequences 502 for dilation growth factor k (1≤k≤M−1). In some examples, the dilation growth factor may be greater than two.

Each convolutional sequence 502 may include convolutional filters 504, an activation function 506, a batch normalization 508, and another convolution layer 510. In some examples, the convolutional filters 504 may include k×1 causals, where each causal means a convolutional filter.

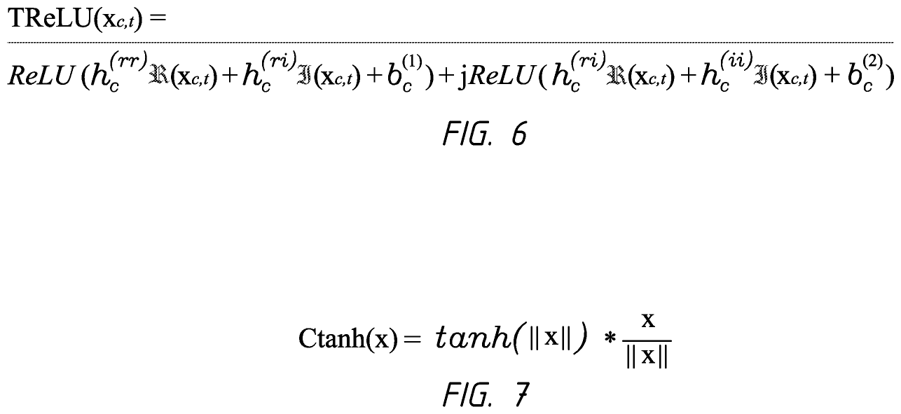

To approximate conjugate operation and phase scaling where a phase of a complex number is multiplied by a constant, the executable instructions for neural network 122 may include instructions to perform a component-wise operation before a rectifier activation function. An example combination of the component-wise operation and the rectifier activation in the executable instructions for neural network 122 may be represented as the activation function 506. For example, FIG. 6 shows an activation function 506 used in the convolutional sequence 502 in accordance with examples described herein. The activation function 506 may be represented as TReLU(x_{c, t}) in an equation of FIG. 6. In the equation, x is a complex input of the activation function (TReLU), c and t are the channel and time indices, respectively, and h and b are parameters to train. The activation function 506 operation linearly transforms the two-dimensional complex space that may simulate both conjugate and phase scaling, and then a rectifier activation (ReLU) may be performed on real and imaginary parts independently. After performing the activation function 506, the batch normalization 508 may be performed, followed by the convolution layer 510.

After separation, a complex mask ranging from 0 to 1 that is multiplied with an output of complex encoding may be provided for complex decoding. While the mask cannot go beyond 1, a trainable encoder and decoder may mitigate this limitation. For example, FIG. 7 shows a hyperbolic tangent function used after the convolutional sequence 502 in accordance with examples described herein. The hyperbolic tangent function may be applied to an amplitude of an output signal of the convolution layer 510 represented in the complex tensor x. Thus, the amplitude of an output signal represented in the complex tensor x may be controlled while preserving an angle component of the complex tensor x.

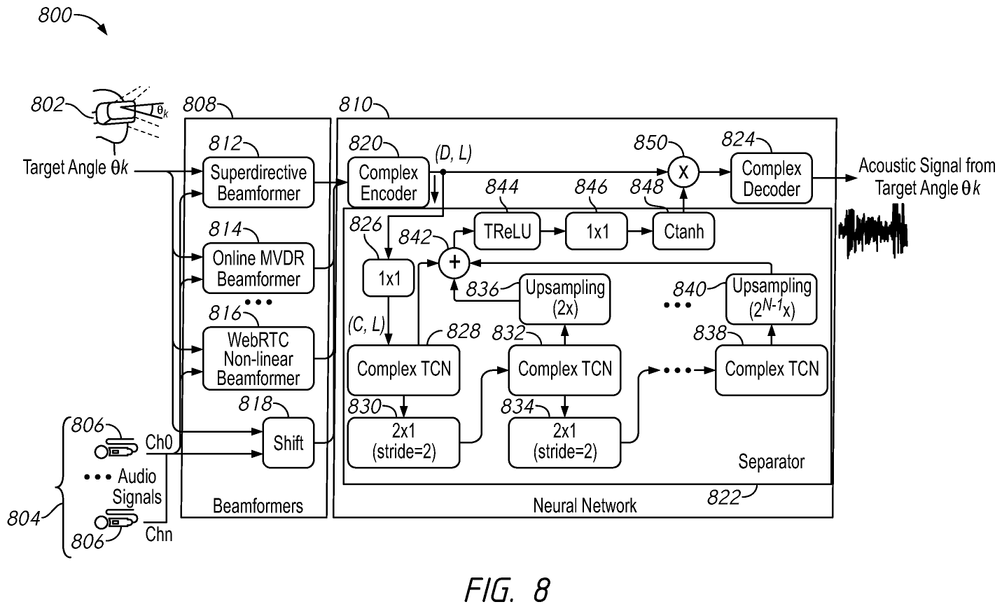

FIG. 8 is a schematic illustration of an example system 800 using directional audio source separation in accordance with examples described herein. The system 800 includes a direction sensor 802, a microphone array 804 including microphones 806, prebeamformers 808 and a neural network 810. The prebeamformers 808 may include a superdirective beamformer 812, an online MVDR beamformer 814, a WebRTC non-linear beamformer 816 and a shift module 818. The neural network 810 may include a complex encoder 820, a separator 822, and a complex decoder 824. The separator 822 may include an input padding 826, a TCN 828, convolution layers for downsampling 830, a TCN 832, convolution layers for downsampling 834, an upsampler 836, a TCN 838, an upsampler 840, an adder 842, an activation function 844, a convolution layer 846, a hyperbolic tangent function 848, and a multiplier 850. In some examples, the direction sensor 802 may be the direction sensor 108, the microphone array 804 may be the microphone array 104. The prebeamformers 808 may be implemented as the computing device 102 with the processor 112 that performs the executable instructions for pre-beamforming 120. The neural network 810 may be implemented as the computing device 102 with the processor 112 that performs the executable instructions for neural network 122.

It should be understood that the system 800 shown in FIG. 8 is an example of one suitable architecture for implementing certain aspects of the present disclosure. Additional, fewer, and/or different components may be used in other examples. In some examples, the system 800 is illustrated as a wearable device. However, it should be noted that implementations of the present disclosure are applicable to other types of devices such as mobile computing devices and static computing devices that accept sound input and directional information and provide sound output. For example, such devices may be medic devices. Any and all such variations, and any combination thereof, are contemplated to be within the scope of implementations of the present disclosure.

The direction sensor 802 and the microphones 806 may be mounted on a wearable device. In some examples, the wearable device may be a headphone, a VR device such as a VR headset, or an AR device, such as an AR headset or a smart glass, mounted on a head. The direction sensor 802 may be a gaze tracker of the wearable device. The microphone array 804 may include the microphones 806. While two or more microphones 806 are shown in FIG. 8, generally any number of microphones may be included in a microphone array described herein. Moreover, the microphones 806 may be arranged in an array or in a dispersed manner, such as at vertices of a polygon, etc. In some examples, the microphones 806 may be positioned on an augmented or virtual reality headset. However, other arrangements of direction sensor and/or microphones may be used in other examples.

The microphones 806 may receive input acoustic signals as multi-channel audio signals from a plurality of sound sources emitted from a plurality of angles (e.g., angles θ_{1 . . . N}), including a target acoustic signal from a target direction (e.g., a direction with a target angle θₖ).

The direction sensor 802 may generally obtain a target direction and provide direction information indicative of the target direction (e.g., a direction with a target angle). In some examples, the direction sensor 802 may be a gaze tracker of the wearable device, such as an AR device, mounted on a head. Combining angle information using sets of video information of an eye on the head and an outer world with regard to the wearable device, a target direction (e.g., a direction with a target angle) may be obtained. The microphone array 804 and the direction sensor 802 may be communicatively coupled to a computing device, such as the computing device 102, that is capable of directional audio source separation in accordance with examples described herein.

The input acoustic signals received by the microphones 806 and the obtained direction information may be provided to the prebeamformers 808. In some examples, the prebeamformers 808 may be implemented as the executable instructions for pre-beamforming 120 executed by the processor 112. The prebeamformers 808 may include a plurality of beamformers that may be different from one another. In some examples, the prebeamformers 808 may include a superdirective beamformer 812, an online MVDR beamformer 814, and a WebRTC non-linear beamformer 816. The superdirective beamformer 812, the online MVDR beamformer 814, and the WebRTC non-linear beamformer 816 may receive the input acoustic signals received by the microphones 806 and the obtained direction information, and perform respective beamforming. The superdirective beamformer 812 may extract an acoustic signal of a sound under diffused noise. The online adaptive online MVDR beamformer 814 may extract the spatial information from the past to suppress noise and interference. The WebRTC non-linear beamformer 816 may enhance a simple delay-and-sum beamforming by suppressing time-frequency components that are more likely noise or interference. These three statistical beamformers, for example, may provide different classes of beamforming techniques from non-adaptive, adaptive and non-linear approaches. These three statistical beamformers 812, 814 and 816 are merely examples; any combination of beamformers may be included to perform different classes of beamforming techniques. As a result, the prebeamformers 808 generate a plurality of beamformed signals that may provide a diversity of spatial information.

Additionally, the prebeamformers 808 may include the shift module 818. Input channels for the microphones 806 may be shifted to aim at an input direction, and each microphone 806 samples an input acoustic signal through each direct path simultaneously, and the signal \hat{ }y(f) based on the shifted channel based on the input channels y(f) may be computed as an equation in FIG. 3. In the equation, tᵢ(θ) is the time-of-arrival from direction θ on mic i. The signals on shifted channels along with the plurality of beamformed signals and the input acoustic signals from the microphones 806 may be provided into the neural network 810 implemented by the executable instructions for neural network 122.

The neural network 810 may include a complex encoder 820, a separator 822, and a complex decoder 824. The complex encoder 820 may encode the signals from the prebeamformers 808 with parameters in the instructions in complex tensor representation to reduce a model size of the neural network 810. For example, each value can be represented as [R, −I; I, R], instead of full 2×2 matrices while maintaining a comparable accuracy. Furthermore, the complex tensors may restrict a degree of freedom of the parameters by enforcing correlation between the real and imaginary parts of the parameters, which enhances generalization capacity. The complex tensors may provide signal phase manipulation that enables encoding spatial information. The encoded signals may be provided to the separator 822.

The separator 822 may provide a separated acoustic signal from the target direction θ in a complex tensor representation. The complex decoder 824 may decode the separated acoustic signal from the separator 822 in the complex tensor representation multiplied by the output signal of the complex encoder 820 by the multiplier 850 to a real value, and provide the decoded signal as an output acoustic signal from the target direction θ.

The separator 822 may include dilated and strided complex convolution stacks. The dilated and strided complex convolution stacks may include an input padding 826, a TCN 828, convolution layers for downsampling 830, a complex TCN 832, convolution layers for downsampling 834, an upsampler 836, a complex TCN 838, an upsampler 840, and an adder 842.

In some examples, each complex TCN of the complex TCNs 828, 832, . . . , and 838 may include a plurality of dilated convolution layers. Each complex TCN of the complex TCNs 828, 832, . . . , and 838 may be implemented as the TCNs 402a and 402b. Between two adjacent complex TCNs, a 2×1 convolution layer, such as the convolution layers for downsampling 830 and/or convolution layers for downsampling 834 with stride being two, has been included. Each convolution layer of the convolution layers other than a last convolution layer in each complex TCN except the last complex TCN 838 may provide output signals to each later adjacent layer. Each last convolution layer 406 of the plurality of dilated convolution layers of the complex TCNs except the last complex TCN 838 may provide one or more signals to the adjacent 2×1 convolution layer. The convolution layers for downsampling 830, 834, . . . may downsample the one or more signals from the prior adjacent complex TCNs 828, 832, . . . and provide a signal that is a downsampled signal to the other later adjacent complex TCNs 832, . . . . The signal provided to the later layer may be upsampled by the upsamplers 836, 840, . . . using the nearest neighborhood method accordingly to an original sampling rate before summing up. Thus, a combination of strided and dilated convolution stacks may reduce a memory copy overhead caused by copying data from input padding to a current buffer and shifting the input padding for a new buffer. The dilated and strided complex convolution stacks may reduce memory footprint and memory copy per time step while keeping a large receptive field. The last convolution layer of the TCNs 828, 832, . . . , 838 may also provide the one or more signals to a non-adjacent later layer (skip-connection). By reducing the skip-connections limiting to the last convolution layer of each TCN, computations may be reduced. The output signal from the complex TCN 828 and the upsampled signals from the upsamplers 836 . . . 840 may be provided to the adder 842.

The adder 842 may add the received signals, and an added signal may be provided to apply an activation function 844, another convolution applied by a convolution layer 846, and a hyperbolic tangent function 848 that provides an output signal of the separator 822 to the multiplier 850. In some examples, the activation function 844 may be a combination of the component-wise operation and the rectifier activation in the executable instructions for neural network 122 represented as the activation function TReLU(x_{c, t}) in an equation of FIG. 6. The hyperbolic tangent function 848 may be shown as a hyperbolic tangent function of FIG. 7.

Using complex tensors throughout the neural network 810 may reduce a model size of the neural network 810 while achieving a comparable accuracy. Compared to real-valued networks, complex representation also restricts the degree of freedom of the parameters by enforcing correlation between the real and imaginary parts, which enhances the generalization capacity of the model since phase encodes spatial information. A combination of dilated and strided complex convolution stacks may reduce memory footprint and memory copy per time step while keeping a large receptive field. TCNs with limited skip-connection may run more efficiently.

Systems and methods performing directional audio source separation using pre-beamforming and a neural network have been described. Examples of such directional audio source separation systems and methods may facilitate fast computation by using pre-beamforming suitable for performance on wearable and/or medical devices, and may provide comparable accuracy to more complex systems using neural networks described herein for processing multi-channel audio input signals. Thus, examples of methods described herein may provide directional acoustic signals with comparable accuracy from a desirable direction and low-latency suitable for wearable devices. In an augmented reality (AR) or virtual reality (VR) headset, the systems and methods may preferentially and timely reproduce sound that originates from a gaze direction of a wearer of the headset, thus improved reality experience, such as in augmented or virtual activities (e.g., sports, AR/VR games, remote operations, such as medical operations, manufacturing operations, etc.) may be provided to the wearer. In another example, in a hearing aid, the systems and methods may produce sound with a directional preference based on a gaze, a head direction, or other direction of a user based on a configuration, thus the user of the hearing aid may be able to react to sound from a certain direction without delay, which leads to safe reactions of the user to any hazardous activities surrounding the user. While various advantages of example systems and methods have been described, it is to be understood that not all examples of the described technology may have all, or even any, of the described advantages. Accordingly, when directional signals are provided to speakers in accordance with systems and methods described herein, the speaker may generate sound that corresponds to and/or emphasizes sound originating from a particular direction (e.g., an actual or simulated direction). In an AR/VR headset, sound may be heard from the speaker which is from a particular direction and/or emphasizes sound sources in a particular direction.

From the foregoing it will be appreciated that, although specific embodiments of the disclosure have been described herein for purposes of illustration, various modifications may be made without deviating from the spirit and scope of the disclosure.

The particulars shown herein are by way of example and for purposes of illustrative discussion of the preferred embodiments of the present disclosure.

Unless the context clearly requires otherwise, throughout the description and the claims, the words ‘comprise,’ ‘comprising,’ and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

### Implemented Examples

### Evaluation

In an evaluation of an example implementation of the system 800 as a model described herein, a neural network was prototyped and trained and the model rewritten to support NHWC tensor layout (TensorFlow), which may be faster on mobile CPUs. The model was converted to the input formats of two DNN inference engines, MNN (Alibaba) and Arm NN SDK for supporting NEON and 16 bit float (FP16) primitives for ARMv8.2 CPUs (ARM). For accessing the microphones in real-time, PulseAudio was used with a sampling rate of 16 kHz and 16 bit bitwidth.

### Simulated Dataset

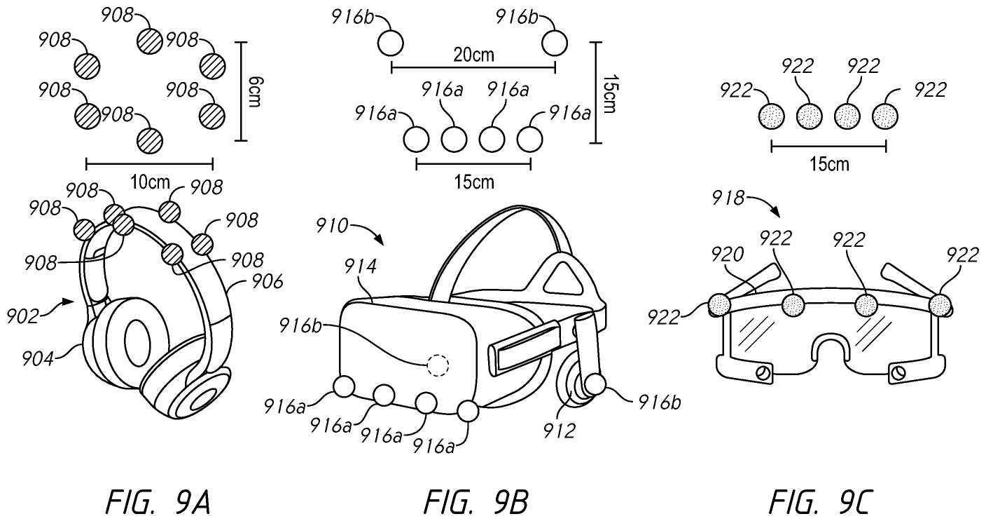

To gather a large amount of training data, software to simulate random reverberate noisy rooms using the image source model was used. The rooms were simulated using absorption rates of real materials and a maximum RT60 of 500 ms. By default, a virtual 6-mic circular array with a radius of 5 cm was used. The distance between the virtual speakers and the microphone array was at least 0.8 m, and the direction of arrival differences of the speakers was at least 10°. The input direction was modeled as the groundtruth plus a random error less than 5° simulating the gaze tracking measurement error. Virtual speakers were placed at random locations within the room playing random speech utterances from the VCTK corpus (CSTR, University of Edinburgh), meanwhile simulating diffused noise from the Microsoft Scalable Noisy Speech Dataset (MS-SNSD) and WSJ0 Hipster Ambient Mixtures (WHAM!) dataset (Wichern). The combined speech power to noise ratio was randomized between [5, 25] dB. 10%, 40%, 40%, 10% of the generated clips consisted of one to four speakers, respectively, and we applied random gain within [-5, 0] dB to each speaker. Speech utterances were provided to overlap for two to four speaker scenarios. The synthetic audio was rendered to generate 4 s clips. A total of 8000 clips as training set were generated, including 400 clips as validation set, and 200 clips as test set. No speech clips or noise appeared in more than one of these three sets. To evaluate the performance on different microphone number and array layouts on various wearable form factors, additional datasets were created using three custom microphone array layouts on a virtual reality (VR) headset as shown in FIGS. 9A-9C.

FIG. 9A is a schematic illustration of an example microphone array arrangement on a headphone 902 in accordance with examples described herein. FIG. 9A shows a top view of the microphone array arrangement and a perspective view of the microphone array arrangement of the headphone 902. The headphone 902 includes a speaker 904, a headband 906, and microphones 908 on the headband 906. The microphones 908 may be positioned at vertices of a hexagon on the top of the headband 906 as shown in FIG. 9A.

FIG. 9B shows a top view of the microphone array arrangement and a perspective view of the microphone array arrangement of an AR headset 910. FIG. 9B shows a top view of the microphone array arrangement and a perspective view of the microphone array arrangement of the AR headset 910. The AR headset 910 includes speakers 912, a stereoscopic display 914, microphones 916a on the stereoscopic display 914 and the microphones 916b on the speakers 912. The microphones 916a may be aligned on a bottom edge of the stereoscopic display 914, and each of the microphones 916b may be positioned on each of the speakers 912.

FIG. 9C shows a top view of the microphone array arrangement and a perspective view of the microphone array arrangement of a pair of smart glasses. FIG. 9C shows a top view of the microphone array arrangement and a perspective view of the microphone array arrangement of a pair of smart glasses 918 in accordance with examples described herein. The pair of smart glasses 918 includes a frame 920 and microphones 922 on the frame 920. The microphones 916a may be aligned on a top of the frame 920.

### Model Specification

Two specifications were used to model the neural network. The encoder and decoder both had a kernel size of 32 and a stride of 8. Different hyperparameter sets were tested. The lookahead came from the transposed convolution in the decoder. Three baselines for reference were used: 1) traditional, online MVDR beamformer; 2) modified Temporal Spatial Neural Filter (TSNF), with replacement of the TasNet structure with a causal Conv-TasNet structure. The identical encoder as the encoder implemented in the system 800 was used to achieve the same lookahead duration; and 3) modified TAC-FasNet (TAC-F), where bidirectional recurrent neural network (RNN) was replaced with directional RNN for causal construction. The same alignment operation was conducted to the multi-channel input acoustic signals before feeding into the network, and only one channel was outputted.

### Training Procedure

When synthesizing each training audio clips, another version was synthesized. In the version, only one of the sound source and the first microphone were present, and no reverberation was rendered. This version was used as the groundtruth when the direction input was the direction of the present source. Hence, the model was trained to simultaneously do de-reverberation, source separation and noise suppression. A 1:10 linear combination of scale-invariant signal to distortion ratio (SI-SDR) and mean L1 loss were used as training subjective. The 1:10 linear combination of SI-SDR was used to measure the speech quality, and the mean L1 loss regulated the output power to be similar to the groundtruth.

### Network Evaluation on Synthetic Datasets

A DNN-based system was found to outperform a traditional MVDR beamformer. The system 800 with a slightly larger model achieved comparable results with the causal and low lookahead version, but using a significantly fewer number of parameters and computation. Two variants of the large model were evaluated. First, 16 bit float format (FP16) instead of 32 bits was used, and only a 0.2 dB drop in both SI-SDRi and SDRi was observed. Using FP16 drastically reduced the inference time on platforms that support native FP16 instructions. Next, the three beamformers were removed and the network was retrained. The SI-SDRi drops by more than 2 dB, which shows the usefulness of pre-beamforming. Bootstrapping sampling techniques were used to evaluate testset 100 times. The 25th, 50th and 75th percentiles were 12.99 dB, 13.32 dB and 13.61 dB, respectively, on a HybridBeam+ model. The training set contained all one to four sources of the custom microphone array layouts to obtain performance on the testset under a same trained model and the SI-SDRi results were observed. Adding microphones was found to consistently improve the result of more than one source cases. The performance with different reverberation time (RT60) was also evaluated. Performance degradation with a RT60 greater than 0.6 s, likely due to a limited receptive field, was observed. When one of the three beamformers was removed and the network was retrained, and the system 800 was provided with only one reference channel (the first microphone channel) without shifting along with the output of the beamformers as input, the resulting SI-SDRi was only 0.2 dB lower, which indicates the usefulness of pre-beamforming. The separation performance was also observed to increase as the angular difference between the sources was increased. When there was no direction error in the input, the SI-SDRi improved for smaller angular differences. The results were compared with two real-valued networks with the same structure: (1) a real-valued version trained with dimensions adjusted to match the number of trainable parameters in a complex-valued network and (2) a real-valued network constructed with a same number of CNN channels (thus, twice the number of trainable parameters). The first network had a 0.5 dB SI-SDRi drop compared to the complex network. The second topline network achieved a 0.6 dB SI-SDRi gain. The results prove that the complex-valued network as shown in FIG. 8 is a good tradeoff.

### On-Device Latency Analysis

Models on two mobile development boards were deployed to measure the processing latency: a Raspberry Pi 4B with a four-core Cortex A-72 CPU and a four-core low-power Cortex A-55 development board which supports FP16 operations, both running at 2 GHz. The former is a popular $35 single-board computer, and the latter CPU is designed for low-power wearable devices and efficient cores on smartphones for lightweight tasks like checking emails. The model was operated in real-time and the buffer size set to 128 samples (8 ms). The processing time should be less than 8 ms to guarantee real-time operation. The result showed that comparable source separation performance inference using the model took a much shorter time. Specifically, memory copy overhead was significantly reduced because of the strided dilated convolution, so did computation because of an overall smaller model with vanilla convolution. Finally, with a lookahead of 1.5 ms, the models can run on two platforms in real-time with a 17.5 ms end-to-end latency.

### Network Evaluation on Hardware Data

Hardware dataset. To evaluate model generalization, a headset prototype was implemented and tested with actual hardware. A Seeed ReSpeaker 6-Mic Circular Array kit was modified, and the microphones were placed around a HTC Vive Pro Eye VR headset. The headset's gaze tracker provided the direction of arrival for the model. In addition to generating synthesized data using the above procedure but with the actual microphone layout, hardware data were collected in two different rooms: one large, empty and reverberate conference room (approximately 5×7m2), denoted as Room La, and one smaller, regular room with desks (approximately 3×5m2), denoted as Room Sm. The playback speech was from the same VCTK dataset but played from a portable Sony SBS-XB20 speaker. The speaker was placed at 1 m and different angles within −75° to 75°. The speaker-microphone delay and phase distortions in an anechoic chamber were calibrated using a chirp signal and the same calibration was applied to the original signal. After data collection, two recordings whose direction of arrival difference was more than 10° were randomly added as the mixture signal. The calibrated original speech and the direction of arrival of one of them were picked as groundtruth and input direction to the model. The model was used to test on hardware datasets collected in the conference rooms. The test was conducted to see whether training on only synthesized data can generalize to hardware data. The best baseline was chosen on the synthetic datasets for comparison. Unlike the existing model, which sometimes predicts wrong sound sources, mostly because the features used by TSNF are highly affected by noise and interference and are not robust in real-world scenarios, the model of the system 800 generalizes and outperforms MVDR baseline. The 50% actual recordings were mixed with 50% synthesized data as the training set and tested on the recordings in another room. The model of the system 800 performs better and achieves another 3 dB gain compared to the existing model, regardless of the room acoustic properties.

What is claimed is:

1. A method comprising:
receiving a plurality of input signals by a plurality of microphones;
generating a plurality of beamformed signals based on the plurality of input signals;
providing the plurality of beamformed signals and the plurality of input signals to a neural network, wherein the neural network is trained to generate directional signals based on sample beamformed signals and sample input signals;
generating an output directional signal using the neural network based on the plurality of input signals and the plurality of intermediate signals; and
providing the directional signal to a speaker.

2. The method of claim 1, wherein generating the output directional signal using the neural network comprises using direction information in the plurality of beamformed signals, and
wherein the output directional signal comprises an acoustic signal in the input signals projected from a direction based on the direction information.

3. The method of claim 2, further comprising detecting the direction information by a sensor.

4. The method of claim 1, wherein the neural network is configured to utilize a complex tensor.

5. The method of claim 4, wherein the neural network is configured to:
perform a component-wise operation; and
perform a rectifier activation function.

6. The method of claim 4, wherein the neural network is configured to apply a hyperbolic tangent function to an amplitude of the complex tensor.

7. The method of claim 1, wherein the neural network comprises a plurality of temporal convolutional networks (TCNs) including a first TCN and a second TCN, and
wherein the method further comprises:
downsampling a first TCN signal from the first TCN; and
providing a second TCN signal that is the downsampled first TCN signal to the second TCN.

8. The method of claim 7, wherein the first TCN comprises a plurality of convolution layers,
wherein a last convolution layer of the plurality of convolution layers is configured to provide the first TCN signal, and
wherein the last convolution layer is further configured to provide the first TCN signal to a later layer that is not adjacent to the last convolution layer.

9. The method of claim 1, wherein the plurality of beamformed signals comprise spatial information.

10. The method of claim 1, wherein
generating the plurality of beamformed signals comprises:
generating a first plurality of beamformed signals using a first beamforming process on the plurality of input signals; and
generating a second plurality of beamformed signals by using a second beamforming process on the plurality of input signals, and
wherein the first beamforming process and the second beamforming process are different from one another.

11. The method of claim 8, wherein the first beamforming process is one of superdirective beamforming, online minimum-variant distortionless-response (MVDR) beamforming, Web Real-Time Communication (RTC) non-linear beamforming, or binaural beamforming, and
wherein the second beamforming process is one of superdirective beamforming, online MVDR beamforming, WebRTC non-linear beamforming or binaural beamforming that is different from the first beamforming.

12. A system comprising:
a plurality of microphones;
first circuitry configured to beamform input signals received at the plurality of microphones to first intermediate signals;
second circuitry configured to beamform the input signals to second intermediate signals;
a neural network, the neural network trained to generate a directional signal based on sample input beamformed signals, the neural network coupled to the first circuitry and the second circuitry, the neural network configured to generate an output directional signal based on the first intermediate signals, the second intermediate signals, and at least a portion of the input signals; and
a speaker coupled to the neural network and configured to play the output directional signal.

13. The system of claim 12, wherein the neural network comprises an encoder, a separator, and a decoder.

14. The system of claim 12, wherein the plurality of microphones are positioned on top of a headband of a headphone, and wherein the speaker is positioned in the headphone.

15. The system of claim 12, wherein the plurality of microphones are positioned on an augmented or virtual reality headset, and wherein the speaker is positioned in the augmented or virtual reality headset.

16. The system of claim 12, wherein the first circuitry and the second circuitry are configured to utilize direction information.

17. The system of claim 12, wherein the neural network is configured to utilize complex tensors.

18. The system of claim 12, wherein the neural network is further configured to:
perform a component-wise operation; and
perform a rectifier activation function.

19. The system of claim 18, wherein the neural network comprises a plurality of temporal convolutional networks (TCNs) including a first TCN and a second TCN, and
wherein the neural network is further configured to:
downsample a first TCN signal from the first TCN; and
provide a second TCN signal that is the downsampled first TCN signal to the second TCN.

20. The system of claim 12, wherein the first circuitry is configured to perform one of superdirective beamforming, online MVDR beamforming or WebRTC non-linear beamforming, and
wherein the second circuitry is configured to perform one of superdirective beamforming, online MVDR beamforming or WebRTC non-linear beamforming that is different from the first circuitry.
